(19) United States
(12) Patent Application Publication
(10) Pub. No.: US 2014/0147120 A1
(43) Pub. Date: May 29, 2014

(54) Grooming Multicast Traffic in Flexible Optical Wavelength Division Multiplexing WDM Networks

(71) Applicant: NEC Laboratories America, Inc., Princeton, NJ (US)

(72) Inventors: Ankitkumar N. Patel, Monmouth Junction, NJ (US); Philip Nan Ji, Plainsboro, NJ (US); Ting Wang, West Windsor, NJ (US)

(73) Assignee: NEC Laboratories America, Inc., Princeton, NJ (US)

(21) Appl. No.: 14/085,000

(22) Filed: Nov. 20, 2013

Related U.S. Application Data
(60) Provisional application No. 61/729,634, filed on Nov. 25, 2012.

(51) Int. Cl. H04J 14/02

(52) U.S. Cl. CPC H04J 14/0238
USPC 398/79

(57) ABSTRACT

The present invention is directed to a solution for grooming multicast traffic in flexible optical wavelength division multiplexing WDM networks. The invention includes a solution for grooming multicast traffic in flexible optical wavelength division multiplexing networks into a solving a multicast routing sub-problem, solving a a grooming sub-problem; and solving a wavelength assignment and spectrum allocation sub-problem.

### RELATED APPLICATION INFORMATION

This application claims priority to provisional application Ser. No. 61/729,634 filed on Nov. 25, 2012, entitled “Multicast Traffic Grooming in Flexible Optical WDM Networks”, the contents thereof are incorporated herein by reference.

### BACKGROUND

The present invention relates optical communications, and, more particularly, to multicast traffic grooming in flexible optical wavelength division multiplexing WDM networks.

The following background documents are discussed in the present application: [ITU-T] ITU-T G.694.1, “Spectral grids for WDM applications: DWDM frequency grid,” May 2002; [A Patel] A. N. Patel, P. N. Ji, J. P. Jue, and T. Wang, “Routing, Wavelength Assignment, and Spectrum Allocation in Transparent Flexible Optical WDM (FWDM) Networks,” Proceeding of OSA Photonics in Switching, PDPWG1, July 2010; [M. Jinno] M. Jinno, H. Takara, B. Kozicki, Y. Tsukishima, Y. Sone, and S. Matsuoka, “Spectrum-Efficient and Scalable Elastic Optical Path Network: Architecture, Benefits, and Enabling Technologies,” IEEE Communication Magazine, pp. 66-73, November 2009; [S Gringeri] S. Gringeri, B. Basch, V. Shukla, R. Egorov, and T. J. Xia, “Flexible Architectures for Optical Transport Nodes and Networks,” IEEE Communication Magazine, pp. 40-50, July 2010; [A Patel2] A. N. Patel, P. N. Ji, J. P. Jue, and T. Wang, “Routing, Wavelength Assignment, and Spectrum Allocation Algorithms in Transparent Flexible Optical WDM Networks,” Optical Switching and Networking, vol. 9, no. 3, pp. 191-204, July 2012; [YWang] Y. Wang, X. Cao, and Y. Pan, “A Study of the Routing and Spectrum Allocation in Spectrum Sliced Elastic Optical Path Networks,” Proc. of INFOCOM, pp. 1503-1511, April 2012; [K Cristodoulopoulos] K. Cristodoulopoulos, I. Tomkos, and E. Varvarigos, “Spectrally/Bitrate Flexible Optical Network Planning,” Proc. of ECOC, no. We.8.D.3, September 2010; [A Patel3] A. N. Patel, P. N. Ji, J. P. Jue, and T. Wang, “Light-Tree Establishment for Optical Multicasting in Flexible Optical WDM (FWDM) Networks,” Proc. of ACP, no. AS2D, November 2012; [A Patel4] A. N. Patel, P. N. Ji, J. P. Jue, and T. Wang, “Traffic Grooming in Flexible Optical WDM (FWDM) Networks,” Proc. of OECC, pp. 405-406, July 2011; [R Mustafa] R. Mustafa and A. Kamal, “Design and Provisioning of WDM Networks with Multicast Traffic Grooming” Journal of Selected Areas in Communications, vol. 24, no. 4, pp. 37-53, April 2006; [R Lin] R. Lin, W. Zhong, S. Bose, and M. Zukerman, “Design of WDM Networks with Multicast Traffic Grooming,” Proc. of OECC, pp. 405-406, July 2011; [Q Wang] Q. Wang and L-K. Chen, “Performance Analysis of Multicast Traffic over Spectrum Elastic Optical Networks,” IEEE/OSA OFCNFOEC, no. OTh3B.7, March 2012

Wavelength Division Multiplexing (WDM) is a promising technology offering high-speed and high-capacity communications to support the emerging global communications traffic. Major portion of this traffic is mainly contributed by, but not limited to, the applications, such as IPTV, video-conferencing, content distribution, grid applications, database backup, software distributions, interactive gaming, consumer television, and distance learning. Instead of a host communicates with another host, which is referred to as a unicast communication, in such applications, a host communicates to a set of hosts, which is referred to as a multicast communication. In optical networks, unicast communications can be realized by only point-to-point optical channels referred to as lightpaths. On the other hand, multicast communications can be realized by not only lightpaths, but also point-to-multipoint optical channels referred to as light-trees (In light-trees, data is transferred from a node to a set of nodes without any electrical conversion at intermediate nodes). Provisioning multicast applications through light-trees improves network efficiency compared to that through lightpaths due to the inherent benefits of light-trees, such as reduced control and management overhead and elimination of traffic redundancy. Furthermore, since a light-tree is a generalization of a lightpath, light-tree based connectivity is more optimized than lightpath based connectivity.

In ITU-T based WDM networks [ITU-T], a light-tree is established by allocating fixed amount of spectrum irrespective of the transmission rate. We refer to such networks as fixed grid networks (FIG. 1(a)). Fixed spectrum assigned to light trees may not be sufficient to support higher line rates. In such case, super-wavelength granularity traffic is supported through multiple light-trees and excessive spectrum needs to be allocated in terms of guard bands to avoid inter-channel interference. The spectrum allocated to guard bands cannot be utilized for data transmission. On the other hand, if sub-wavelength granularity traffic is supported through higher line rates light-trees, then the assigned spectrum to light-trees may be excessive. Thus, in fixed grid networks, spectrum efficiency may not be optimized due to rigid spectrum assignment to light-trees.

There has been growing research interests on optical WDM systems those are not limited to fixed ITU-T channel grid, but offer flexible channel grid to increase spectral efficiency [A Patel] [M Jinno] [S Gringeri]. We refer such networks as Flexible optical WDM networks (FWDM) (FIG. 1(b)). In [A Patel2] [Y Wang] [K Christodoulopoulos], benefits of FWDM networks are demonstrated for lightpath-based unicast communications. Recently in [A Patel3], we demonstrate that supporting multicast traffic over end-to-end light-trees can dramatically improve network spectral efficiency compared to end-to-end lightpaths. In an end-to-end light-tree based communication, a source node is all-optically connected to all the destination nodes without any electrical conversion at intermediate nodes, and in an end-to-end lightpath, a source node is all-optically connected to a single destination without any electrical conversion.

Although, network spectral efficiency can be improved by flexible spectrum assignment to end-to-end light-trees in FWDM networks [A Patel3], guard bands are still required to isolate neighboring light-trees in order to avoid inter-channel interferences. The amount of spectrum allocated to guard bands linearly depends on the number of multiplexed light-trees in a fiber. Thus, supporting network traffic with a large number of finer-granularity end-to-end light-trees may waste large amount of spectral resources in terms of guard bands. An effective solution is to reduce the number of multiplexed light-trees (respective optical channels) while supporting the same amount of traffic passing through a fiber, which can be realized by aggregating, switching, and separating low-speed multicast connections over high-speed light trees. Such functionality is referred to as multicast traffic grooming. The impacts of incorporating traffic grooming functionalities over FWDM networks are investigated in [A Patel4] for lightpath-based communications. In multicast grooming, low-rate multicast connections are groomed over high-capacity light trees. For example, supporting 100 Gb/s multicast traffic by establishing ten 10 Gb/s light-trees requires ten times more spectrum for guard bands compared to aggregating the traffic over a single 100 Gb/s light-tree. Thus, by aggregating finer granularity traffic over existing light trees, multicast traffic grooming reduces the number of stranded light-trees, and thus, improves utilization of allocated resources to existing channels. On the other hand, by reducing the number of multiplexed light-trees over a fiber, multicast traffic grooming diminishes over-provisioning of spectral resources in terms of guard bands.

While provisioning multicast connections in traffic grooming capable FWDM networks, open control plane challenges are how to establish logical light-tree connectivity, how to route and groom traffic over the light-trees, how to route the light-trees over a physical topology, how to assign wavelengths to the light-trees, and how to allocate spectrum to the light-trees. We refer to this problem as multicast traffic grooming problem in FWDM networks that is formally defined as follows.

We are given the configuration of an optical network in terms of the locations of a set of optical nodes V and a set of deployed fibers E connecting optical nodes V. The FWDM network supports a set of line rates L. For example, L={10 Gb/s, 40 Gb/s, 100 Gb/s, 400 Gb/s, 1 Tb/s}. Each line rate lεL requires a spectral width of xₗ GHz. For example, 100 Gb/s line rate requires 50 GHz of spectrum. A multicast traffic demand requesting a connection between source s and a set of destinations D operating at data rate r is denoted as R(s, D, r). The goal of the problem is to find a set of light-trees, routing of traffic over these light-trees (grooming sub-problem), routing of the light-trees over the physical topology (multicast routing sub-problem), and wavelength assignment and spectrum allocation to the light-trees (wavelength assignment and spectrum allocation sub-problem). The objective is to maximize the network spectral efficiency by accommodating the multicast traffic within minimum amount of spectrum. In this work, we assume that each node is capable of multicast and grooming functionalities. The impacts of physical layer impairments are ignored in this study.

While establishing light-trees in FWDM networks, the control plane must observe (a) the wavelength continuity constraint which is defined as an allocation of the same operating wavelength on all branches of a light tree, (b) the spectral continuity constraint which is defined as an allocation of the same amount of spectrum at an operating wavelength on all branches of a light-tree, and (c) the spectral conflict constraint, which is defined as a non-overlapping spectrum allocation to light-trees routed over the same fiber.

Looking at prior efforts by others, in fixed grid networks, the spectrum assigned to each light-tree is fixed and remains the same for all light-trees. Thus, while establishing light-trees, only the wavelength continuity constraint needs to be observed. On the other hand, in FWDM networks, flexible amount of spectrum is allocated to light-trees based on the transmission rate, modulation format, and optical reach. Thus, while establishing light-trees, the additional spectral continuity and spectral conflict constraints must be observed. Thus, the light-tree establishment problem in fixed grid networks is a special case of the same problem in FWDM networks. Thus, existing light-tree establishment procedures in fixed grid networks [R Mustafa] [R Lin] may not be applicable to FWDM networks.

In [Q Wang], the authors propose an end-to-end light-tree establishment procedure in FWDM networks for a dynamic traffic scenario in which traffic demands arrive and depart in a probabilistic manner. Thus, demands must be provisioned in the order of their arrivals and the sub-wavelength granularity multicast traffic is not groomed over high-capacity light trees. In this invention, we investigate the multicast traffic grooming problem in FWDM networks for a static traffic scenario in which a set of multicast traffic demands are given beforehand. Thus, traffic demands can be provisioned in any order and are not restricted to be provisioned in the order of their arrivals as in the dynamic traffic scenario. Furthermore, to improve resource efficiency, these multicast demands can be groomed over high-speed light trees. Thus, our invention and the procedure in [Q Wang] address two different problems. Even if we apply the procedure proposed in [Q Wang] to the multicast traffic grooming problem of this invention, our invention results in at least as optimum solution as the procedure in [Q Wang]. To the best of our knowledge, this invention introduces the first procedure, namely GReedy clustering over sequential meta-heurISTics (GRIST) procedure, to address the multicast traffic grooming problem. This procedure is applicable to design multicast grooming-enable FWDM networks.

Accordingly, there is a need for multicast traffic grooming in flexible optical wavelength division multiplexing WDM networks.

### SUMMARY OF THE INVENTION

A computer implemented method for grooming multicast traffic in flexible optical wavelength division multiplexing WDM networks includes dividing a solution for grooming multicast traffic in flexible optical wavelength division multiplexing networks into a solving a multicast routing sub-problem, solving a a grooming sub-problem; and solving a wavelength assignment and spectrum allocation sub-problem; employing a greedy clustering over sequential meta-heuristics (GRIST) procedure for solving the multicast routing sub-problem using a genetic evolution procedure; employing a greedy clustering procedure for solving the grooming sub-problem; and employing a simulated annealing procedure sequentially for solving the wavelength assignment and spectrum allocation sub-problem.

In an alternative aspect of the same invention, there is provided a system for grooming multicast traffic in flexible optical wavelength division multiplexing WDM networks, the system includes a computer with processor and instructions for dividing a solution for grooming multicast traffic in flexible optical wavelength division multiplexing networks into a solving a multicast routing sub-problem, solving a a grooming sub-problem; and solving a wavelength assignment and spectrum allocation sub-problem; employing a greedy clustering over sequential meta-heuristics (GRIST) procedure for solving the multicast routing sub-problem using a genetic evolution procedure; employing a greedy clustering procedure for solving the grooming sub-problem; and employing a simulated annealing procedure sequentially for solving the wavelength assignment and spectrum allocation sub-problem.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1(a), (b) depicts fixed transmission channel spacing and flexible transmission channel spacing to which the inventive method is directed;

FIG. 2 is a diagram depicting a genetic encoding in accordance with the invention;

FIG. 3 is a diagram depicting an illustrative scenario, in accordance with the invention;

FIG. 4 is a diagram depicting an auxiliary graph, in accordance with the invention;

FIG. 5 is a diagram depicting an initial state of the greedy clustering, in accordance with the invention;

FIG. 6 is a diagram depicting auxiliary clusters for evaluating the best grooming candidate;

FIG. 7 is a diagram depicting evolved clusters after a first iteration, in accordance with the invention;

FIG. 8 is a flow diagram of the GRIST procedure, in accordance with the invention;

FIG. 9 is a flow diagram of the K-Steiner tree procedure, in accordance with the invention; and

FIG. 10 is a flow diagram of the greedy clustering procedure, in accordance with the invention.

### DETAILED DESCRIPTION OF PREFERRED EMBODIMENTS

The present invention is directed to a novel computer implemented method, namely greedy clustering over sequential meta-heuristics, using a hybrid application of the greedy clustering procedure and the naturally-inspired procedures, such as genetic evolution and simulated annealing. The genetic evolution procedure is used to address the multicast routing sub-problem, the greedy clustering procedure is used to address the grooming sub-problem, and the simulated annealing procedure is used to address the wavelength assignment and spectrum allocation sub-problem in a sequential manner.

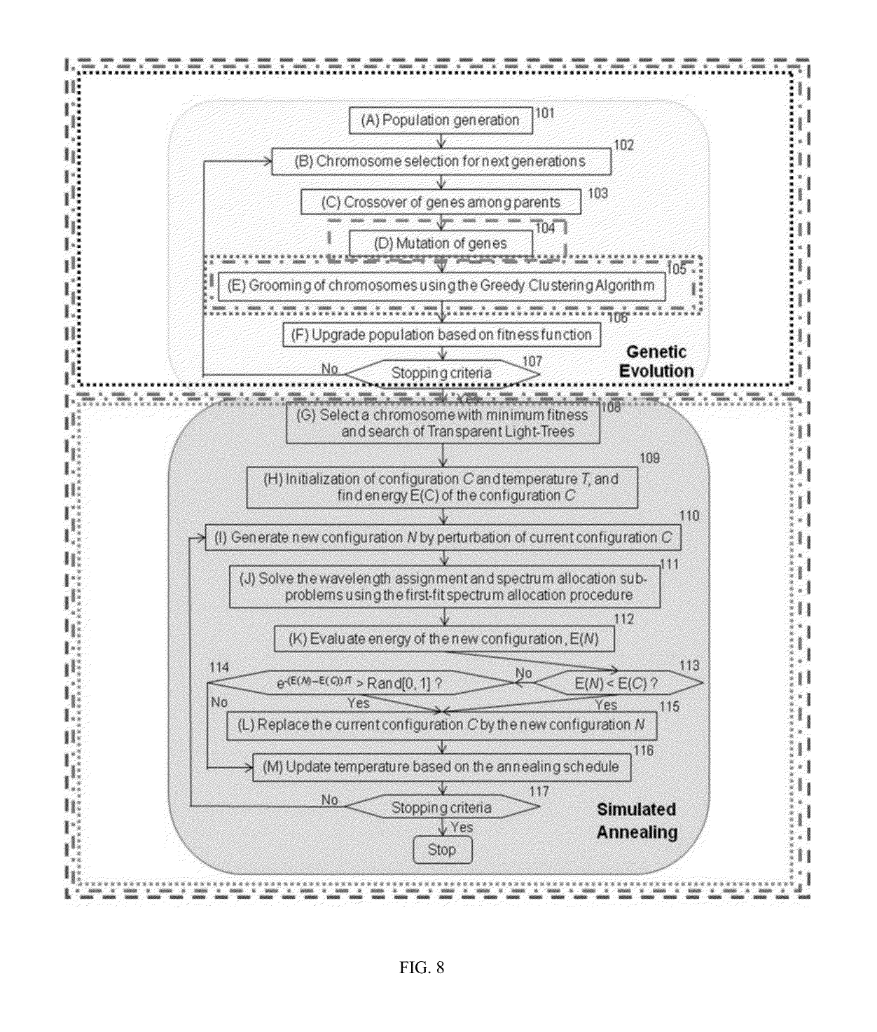

We divide the problem into three sub-problems, routing sub-problem, grooming sub-problem, and wavelength assignment and spectrum allocation sub-problem. GReedy clustering over sequential Meta-HeurISTics (GRIST) procedure addresses the multicast routing sub-problem using the Genetic Evolution procedure, the grooming sub-problem using the Greedy clustering procedure, and the wavelength assignment and spectrum allocation sub-problem using the Simulated Annealing procedure sequentially as shown in FIG. 8.

We first introduce some terminologies to explain the GRIST procedure. The spectrum is discretized in the frequency domain, and the smallest unit of spectrum is referred to as a wavelength slot. The spectrum is defined in terms of the number of consecutive wavelength slots, and the central wavelength slot is referred to as the wavelength of a channel. The state of a wavelength slot is represented as a binary variable; ‘1’ means the wavelength slot is available and ‘0’ means the wavelength slot is occupied. The state information of all wavelength slots of a fiber is referred to as the spectrum availability profile of the fiber link.

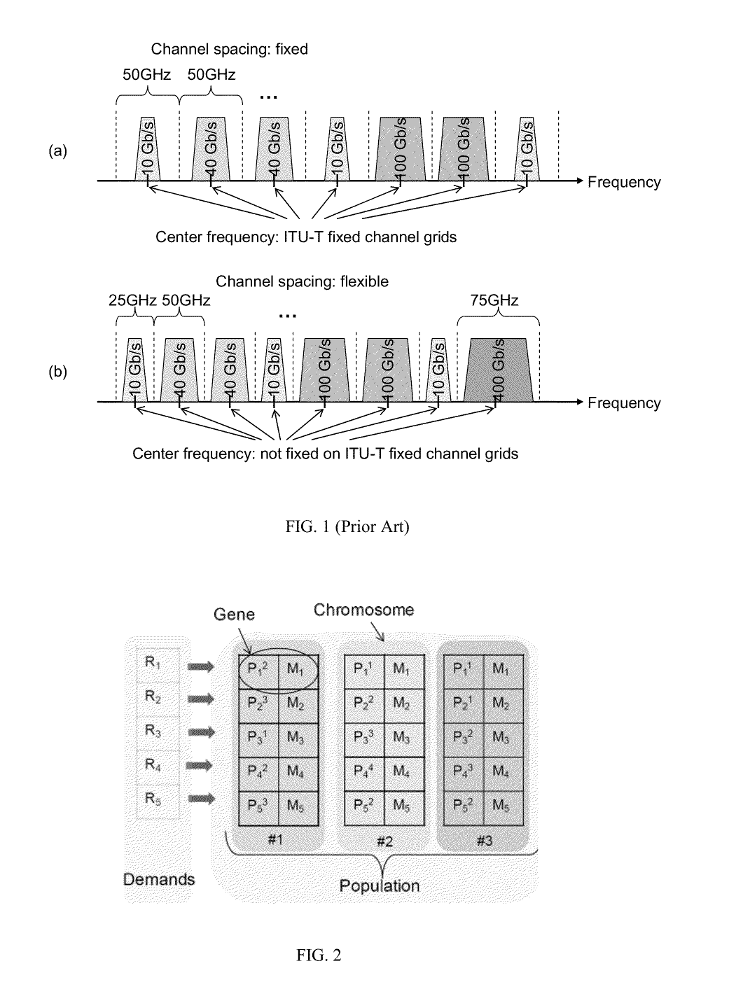

In Genetic Evolution procedure, a genetic encoding (as shown in FIG. 2) is used to map a chromosome to a potential routing and grooming solution of the multicast routing and grooming sub-problems. A set of multicast trees for the given set of traffic demands represents a potential solution of the routing sub-problem. As a grooming solution, the given set of demands is partitioned into groups referred to as clusters. Each cluster is assigned a unique cluster identification (ID). An individual multicast tree and a cluster ID, together, is represented as a gene, and a set of genes for a given set of traffic demands is represented as a chromosome. Multiple genes may be assigned with the same cluster ID, and the cumulative traffic of the demands with the same cluster ID is groomed into a single light-tree. Thus, each gene encodes a feasible multicast tree Pᵢ^{j} and a cluster ID Mᵢ of a traffic demand i, where index j denotes one of the feasible multicast trees of a traffic demand i (THIS IS THE claim 11 OF THIS INVENTION).

A set of such chromosomes represents the population, and the number of chromosomes in the population is referred to as the population size. The fitness of a chromosome is defined as the maximum required spectrum on a fiber link in the network while ignoring the wavelength continuity constraint, which can be mathematically expressed as Max_{(m,n)εE}Σ_{iεC}_{_{(m,n)}}Qᵢ, where Qᵢ denotes the optimum required spectrum to support the cumulative data rate of demands with the same cluster ID i, and C_{(m, n)} denotes a set of cluster IDs assigned to demands routed over the fiber (m, n).

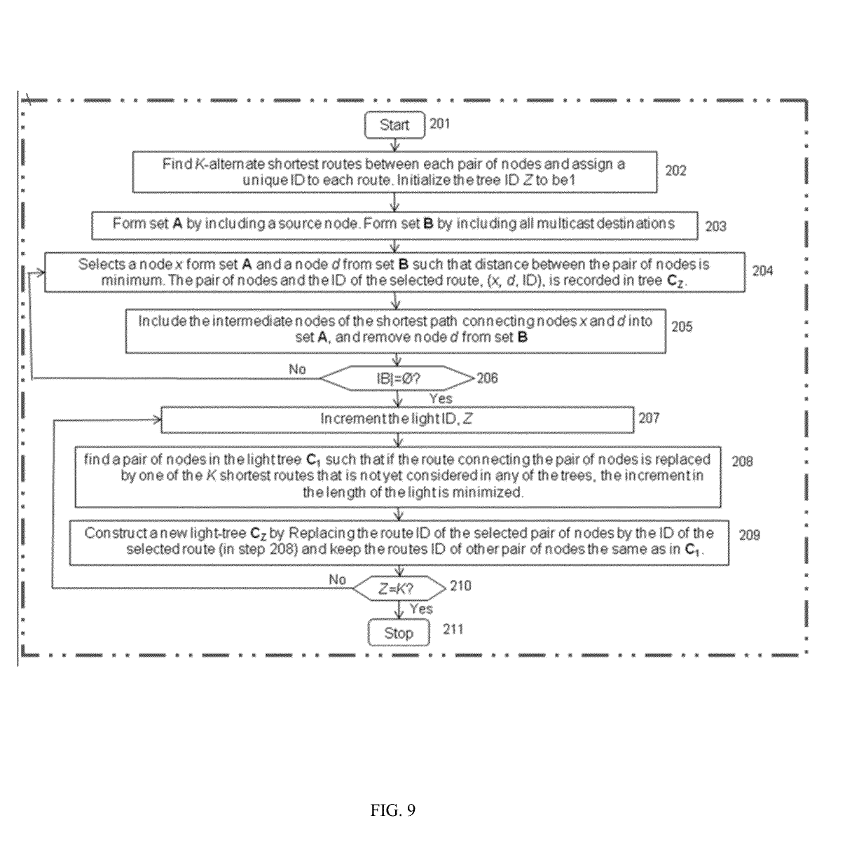

The Genetic Evolution procedure of GRIST algorithm performs the following operations to optimize the multicast routing and grooming of the given set of multicast demands.
(A) Population generation: Population is a set of chromosomes. For each multicast demand, the procedure finds K-alternate Steiner trees using the K-Steiner tree procedure (as shown in FIG. 9). The procedure randomly selects a Steiner tree out of K-alternate Steiner trees with some distribution for each traffic demand, and assigns a unique cluster ID to the demand. The selected Steiner tree and the assigned cluster ID are considered as a gene of a chromosome. Once a chromosome is derived, the procedure repeats the same procedure until the number of chromosomes equivalent to the given population size is generated.
(B) Selection of chromosomes: Patent chromosomes are selected using the Roulette Wheel Selection method in which a chromosome is selected with a probability that is proportional to the fitness of the chromosome. For example, a chromosome i is selected with probability

$$\frac{{f}_{i}}{{\sum }_{j = 1}^{j = N} {f}_{j}} ,$$

where fᵢ denotes the fitness of a chromosome i, and N denotes the number of chromosomes in the population.
(C) Crossover of parent chromosomes: The procedure performs a crossover operation over the selected parent chromosomes to bring diversity in the population. In a crossover operation, chromosome segments (a group of genes) of parent chromosomes are exchanged at the crossover point that is randomly selected, and new child chromosomes are generated.
(D) Mutation: To further introduce population diversity, the child chromosomes are mutated. Based on the given mutation ratio, a number of genes within each child chromosome is randomly selected. With the given mutation probability, the multicast trees of the selected genes are replaced with a multicast tree that is randomly selected out of K-alternate Steiner trees with some distribution.
(E) Grooming of chromosomes: The procedure grooms the multicast demands over the multicast trees encoded as genes of each child chromosome using the greedy clustering procedure.
(F) Population upgrade: Fitness of child chromosomes is evaluated. If a child chromosome has a lower fitness than the fitness of any existing chromosome, then the child chromosome replaces the chromosome with highest fitness to maintain a constant population size.

The genetic evolution procedure stops when variation in the best fitness of the population in a given number of subsequent iterations remains negligible or the procedure has reached up to the maximum number of iterations, otherwise the procedure is repeated. After completion of the procedure, genes of the chromosome with the best fitness represent routing of multicast demands in terms of light-trees.

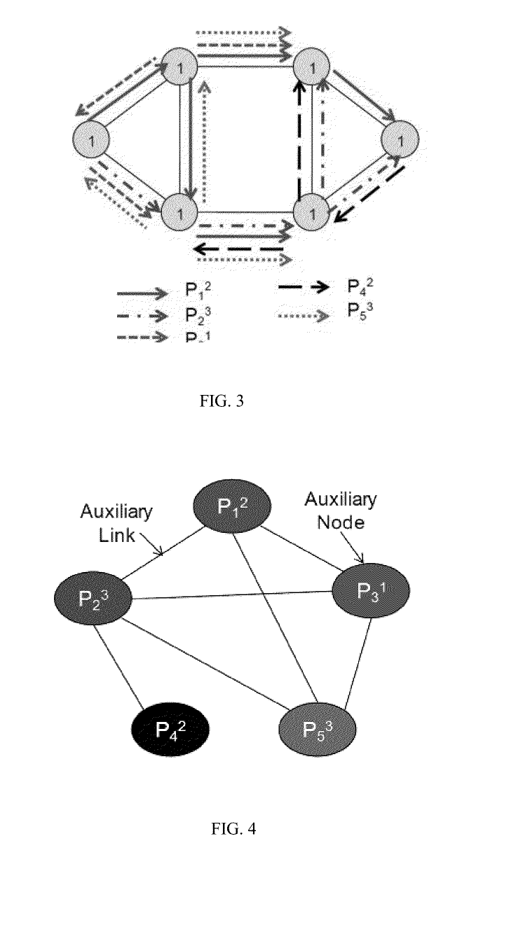

The Genetic Evolution procedure applies the greedy clustering procedure to perform traffic grooming operations. The greedy clustering procedure first constructs an auxiliary graph for a chromosome by considering each multicast tree encoded as a gene Pᵢ^{j} of the chromosome as an auxiliary node. An auxiliary link is established between a pair of auxiliary nodes if the corresponding multicast trees are sharing at least a physical link in the network. FIG. 4 illustrates the auxiliary graph for a scenario presented in FIG. 3. The greedy clustering procedure forms clusters of auxiliary nodes in the auxiliary graph with a greedy strategy. The greedy clustering procedure performs the following operations on the child chromosomes to determine grooming of traffic demands.

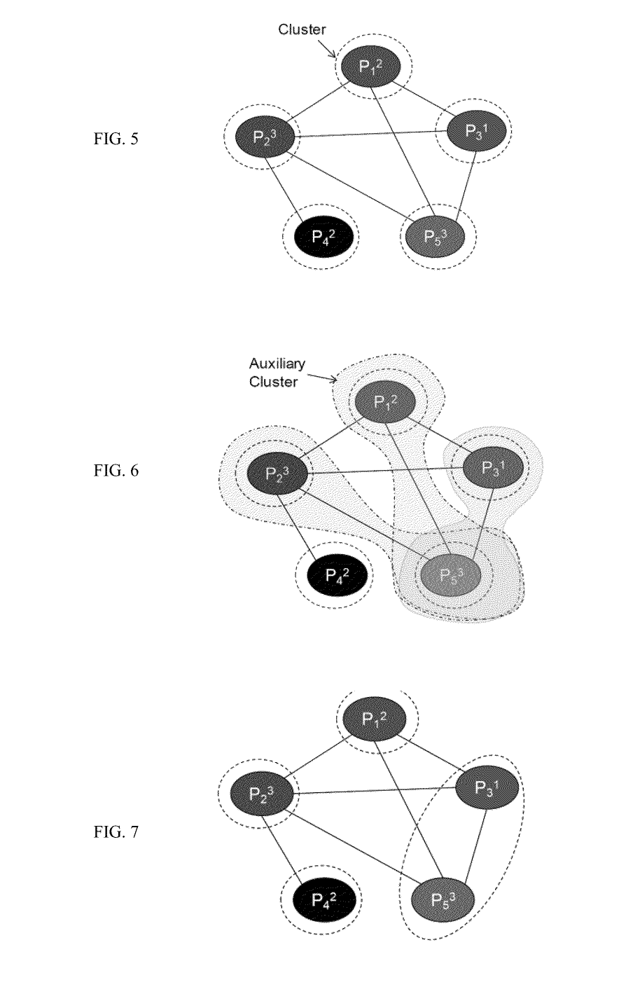

An auxiliary node represents a multicast tree encoded within a gene of a chromosome, and this node is confined in a cluster with the cluster ID encoded within the same gene of the chromosome. Thus, the procedure first constructs an auxiliary graph, and each auxiliary node of the auxiliary graph forms a unique cluster. Thus, in this initial state (no grooming), no traffic demand is groomed with any other demand as shown in FIG. 5. The procedure evaluates the fitness of the chromosome Min-Fit by considering the assigned clusters IDs to the respective multicast trees of the chromosome. The procedure iteratively selects a cluster that is not yet selected in the previous iterations. The selected cluster is combined with each of its neighboring cluster to form an auxiliary cluster (as shown in FIG. 6). The procedure evaluates the cumulative data rate of traffic demands over all the confined multicast trees within an auxiliary cluster. If the cumulative data rate of the cluster is larger than the maximum offered line rate, then the procedure ignores that auxiliary cluster. If the cumulative data rate is smaller than the maximum offered line rate, then the procedure evaluates the fitness function of the chromosome while considering the auxiliary cluster along with other established clusters. While evaluating the fitness of the chromosome, demands within a cluster are considered to be groomed, and demands within an auxiliary cluster are also considered to be groomed. The procedure evaluated the fitness of the chromosome for each of the auxiliary clusters. The procedure selects an auxiliary cluster which results in minimum fitness of the chromosome that is smaller than Min-Fit. The procedure updates the Min-Fit variable with the found minimum fitness. The confined clusters within the selected auxiliary cluster are merged and a single cluster is formed by assigning the same cluster ID to the confined clusters (as shown in FIG. 7). The procedure iteratively considers remaining clusters those are not ever considered in this process. Finally, once all clusters are taken into account, the procedure returns the chromosome with the clustering information Mᵢ.

After addressing the multicast routing and grooming sub-problems, the GRIST procedure determines a logical connectivity of transparent light-trees from the multicast trees and their cluster IDs encoded as genes in the chromosome with the minimum fitness. Each cluster is assigned a light-tree with an optimum line rate such that the capacity of the line rate is larger than the cumulative data rate routed over the confined multicast trees within the cluster and the required spectrum by the line rate is minimum. If the same cluster at an incoming port also exists at any of the outgoing ports, then the light-tree is considered to be bypassed, otherwise the light-tree is considered to be added/dropped at the node.

Once the logical connectivity is determined, the GRIST procedure subsequently solves the wavelength assignment and spectrum allocation sub-problem using the Simulated Annealing procedure. Simulated Annealing is a probabilistic iterative method designed based on a physical process of annealing a solid. In the annealing process, the material is first heated and later cooled in a controlled manner to reduce the internal energy of the material. When the material is heated, the atoms are displaced and they are wondering randomly inside the material. Cooling the material slowly helps atoms finding the best configuration with the lowest internal energy. This process is widely adopted in optimization of combinatorial problems.

In Simulated Annealing, initially a configuration of the solution is selected. This configuration is randomly perturbed to derive a new configuration. The new configuration is randomly selected with certain probability that is a function of the energy difference between the new and current configurations and the global parameter T referred to as a global temperature. At higher temperature, probability of selecting a new configuration is random; however as this temperature decreases, the probability of selecting a new configuration with lower energy increases. Thus, at higher temperature, selecting a configuration with the worst optimization parameter with higher probability avoids the Simulated Annealing procedure being stuck at local optimizations.

In the GRIST procedure, the Simulated Annealing first finds a set of transparent light-trees from the logical connectivity. An order of the found light-trees in which the wavelength assignment and spectrum allocation sub-problem is addressed is considered as a configuration of the Simulated Annealing procedure. The energy function E(C) to be minimized represents the maximum required spectrum over a fiber link in observance of the wavelength continuity, spectral continuity, and spectral conflict constraints (THIS IS THE claim 8 IN THIS INVENTION). The Simulated Annealing procedure adopts the first fit spectrum allocation method to evaluate the energy function. The first fit spectrum allocation method first constructs the bitmap of a light-tree by performing bitwise logical-and operations on the states of wavelength slots in the spectrum availability profile of each link along the light-tree. Finally, consecutive available wavelength slots equivalent to the required spectrum by the line rate of a light-tree are assigned at the lowest available wavelength. The first-fit spectrum allocation procedure is performed in the order of light-trees defined in a configuration C. A temperature is defined as a global time-varying parameter T, and the annealing schedule controls how the temperature varies over time.

The Simulated Annealing of the GRIST procedure performs the following operations to address the wavelength assignment and spectrum allocation sub-problem.
(G) Search transparent light-trees: The procedure first determines a logical connectivity of transparent light-trees from the multicast trees and their cluster IDs encoded as genes in the chromosome with the minimum fitness. Each cluster is assigned a light-tree with an optimum line rate such that the capacity of the line rate is larger than the cumulative data rate routed over the confined multicast trees within the cluster and the required spectrum by the line rate is minimum. If the same cluster at an incoming port also exists at any of the outgoing ports, then the light-tree is considered to be bypassed, otherwise the light-tree is considered to be added/dropped at the node. Thus, the procedure finds a set of transparent light-trees from the logical connectivity.
(H) Configuration initialization: Initially a configuration C is a sequence of light-trees in a descending order of their required spectral width (THIS IS THE claim 12 IN THIS INVENTION). The energy E(C) of a configuration C is determined by solving the wavelength assignment and spectrum allocation sub-problem using the first-fit spectrum allocation procedure in the order of demands defined in the configuration C, and the maximum required spectrum over a fiber is considered as the energy of the configuration.
(I) Configuration generation: A new configuration N is generated from the current configuration C by swapping the order of two neighboring demands those are selected randomly (THIS IS THE claim 12 IN THIS INVENTION).
(J) First-fit spectrum allocation: The found light-trees are assigned wavelengths and are allocated spectrum using the first-fit spectrum allocation procedure in the order of demands defined in the configuration N.
(K) Energy evaluation: The procedure finds the maximum required spectrum over a fiber in the network. The found spectrum represents the energy E(N) of a new configuration N.
(L) Configuration update: If the energy of a new configuration E(N) is decreased compared to the energy of a current configuration E(C), then a current configuration C is replaced by a new configuration N, otherwise a current configuration C is replaced by a new configuration N with a probability

$${e}^{\frac{- ( E ( N ) - E ( C ) )}{T}} ,$$

where T is a current temperature.
(M) Cooling process: The temperature is decreased based on an annealing schedule Tₙ=αTₙ₋₁, where 0.9≦α≦0.99.

The Simulated Annealing process is repeated until either the temperature is reduced to 0 or the maximum iterations per procedure is reached. Finally, the procedure selects a configuration C with the minimum energy, and the energy E(C) represents the minimum required spectrum to support the given set of traffic demands.

FIG. 8 shows the flow chart of the GRIST procedure in more details and the procedure is explained in detail as follows.

In step 101, the procedure generates a population for the genetic evolution procedure. For each multicast demand, a Steiner tree is randomly selected out of K-alternate Steiner trees, connecting a source node s to destination nodes D, with some distribution and assigns a unique cluster ID to the demand, where K-alternate Steiner trees are obtained through the K-Steiner tree procedure described in FIG. 9. The selected Steiner tree and assigned cluster ID are considered as the gene of a chromosome. Once a chromosome is derived, the procedure repeats the same procedure until the number of chromosomes equivalent to the given population size is generated. Thus, each chromosome consists of a light-tree for each auxiliary demand. Based on the given population size, the number of chromosomes are generated. Each gene of a chromosome is assigned with a unique cluster ID.

In step 102, parent chromosomes are selected using the Roulette Wheel Selection method. Step 103 introduces diversity in the population by a crossover operation on the selected parent chromosomes. In a crossover operation, based on the given crossover ratio, a number of chromosome segments (a group of genes) of the parent chromosomes are selected randomly. The selected segments are exchanged among the parent chromosomes to generate new child chromosomes. In step 104, mutation of each novel child chromosome is performed. A number of genes are randomly selected based on the given mutation ratio. With the given mutation probability, the multicast trees of the selected genes are replaced by one of the K-alternate Steiner trees of the respective demand that is randomly selected with some distribution.

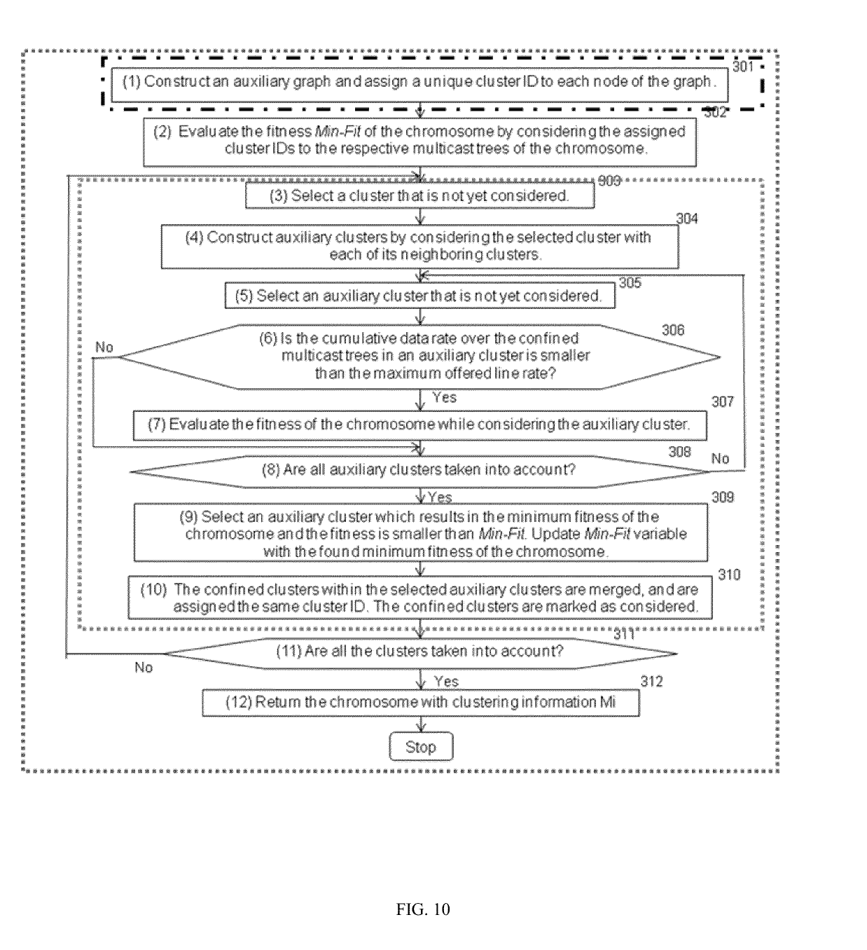

In step 105, for each child chromosome, the procedure grooms the traffic over the multicast trees of the child chromosome using the greedy clustering method as shown in FIG. 10. Step 106 finds the fitness of each child chromosome. If a child chromosome has lower fitness than any existing chromosome in the population, then the child chromosome replaces the chromosome with highest fitness in order to keep the constant population size. Step 107 checks whether the improvement in the fitness function is below the given threshold or the maximum number of iterations are already reached. If either of these conditions is met, then the procedure follows step 108, otherwise the procedure repeats step 102.

Step 108 finds a chromosome with the minimum fitness in the population. The procedure also finds the transparent light-trees based on the multicast routing and clustering information of the selected chromosome. Each cluster is assigned an optical connection with an optimum line rate such that the capacity of the line rate is larger than the cumulative traffic of the demands routed over the multicast trees confined in the cluster and the required spectrum by the line rate is minimum. If the same cluster at an incoming port also exists at any of the outgoing ports, then the light-tree is considered to be bypassed, otherwise the light-tree is considered to be added/dropped at the node.

Step 109 initializes a configuration C with a sequence of light-trees in a descending order of their required spectral width. The energy E(C) of a configuration C is determined by solving the wavelength assignment and spectrum allocation sub-problem using the first-fit spectrum allocation procedure in the order of demands defined in the configuration C, and the maximum required spectrum over a fiber is considered as the energy of the configuration.

Step 110 generates a new configuration N by swapping two neighboring demands that are randomly selected in the current configuration C. Step 111 solves the wavelength assignment and spectrum allocation sub-problem using the first-fit spectrum allocation procedure. In the first-fit spectrum allocation procedure, spectrum is allocated to light-trees of the minimum fitness chromosome yielded in the genetic evolution method at the lowest available operating wavelengths while observing the wavelength continuity and spectral continuity constraints. The spectrum is allocated to the light-trees in the order defined by the configuration N.

Step 112 evaluates the energy function E(N) of the configuration N by finding the maximum required spectrum over a fiber link in the network. Step 13 procedure checks whether the energy E(N) of the new configuration Nis decreased compared to the energy E(C) of the current configuration C. If the energy of the new configuration N is decreased, then the procedure follows step 115, otherwise, the invention follows step 114.

In step 114, the invention generates a random number with a uniform distribution and compares it with the probability of a configuration selection,

$${e}^{\frac{- ( E ( N ) - E ( C ) )}{T}}$$

If the random number is less than the probability of a configuration selection, then the procedure follows step 115, otherwise the procedure follows step 116. Step 115 replaces the current configuration C by the new configuration N. Step 116 updates the temperature based on annealing schedule T=α×T, where 0.9≦α≦0.99.

Lastly, step 117 checks whether the number of iterations is reached to the maximum allowed iterations. If the number of iterations is reached to the maximum iterations, then the procedure stops, otherwise the procedure repeats step 110.

FIG. 9 shows the flowchart of the K-Steiner tree procedure, and the procedure is described in detail as follows.

K-Steiner Tree Procedure:

The K-Steiner tree procedure addresses the following problem. For a given configuration of an optical network in terms of the locations of a set of optical nodes V and a set of deployed fibers E connecting the optical nodes, a given multicast demand with a source node s and a set of multicast destination nodes D, the problem is how to find K minimum cost Steiner trees connecting the source node to all destination nodes. Here, cost is defined in terms of the length of a tree. The number of fiber links used to form a tree represents the length of the tree.

We investigate K-Steiner tree procedure with the application of K-alternate shortest routes [D Eppstein]. The identification (ID) Z of a tree is initialized to 1. The procedure first finds K-alternate shortest routes between each pair of nodes and assigns a unique ID to each found path between a pair of nodes. Let denote A to be a set of nodes along the tree, and B denote a set of destination nodes which are not yet connected to the tree. Initially, A is initialized to a source node, and B is initialized to a set of destination nodes. In the next step, the procedure finds a node x from set A, a node d from set B, and a route connecting the pair of nodes (x, d) such that the distance in terms of number of hops between the pair of nodes is minimized. The pair of nodes and the ID of the selected route (x, d, ID) are recorded in a tree C_{Z}, where the subscript denotes the tree ID. The nodes along the found route are included in set A and the destination node d is removed from set B. This procedure is repeated until all destination nodes are connected in the tree. Once all destination nodes are connected to the tree, the tree C_{Z} represents the minimum cost tree out of K-Steiner trees.

Once the first tree C₁ is established. The remaining K−1 trees are constructed by replacing the route between a single pair of nodes in tree C₁ by one of the K-shortest paths those are not yet considered and which results in the least increment of the length of the tree. The route ID of the selected pair of nodes is replaced by the ID of newly found route out of K-shortest routes and the route ID of the rest of pairs remains the same as in the tree C₁, which represents a new tree. The new tree is recoded in set C_{Z}. The procedure increments the ID Z of a tree, and repeats the process for K−1 times.

In step 201, the procedure starts. In the next step, 202, the procedure finds K-alternate shortest routes between each pair of nodes and assigns a unique ID. The ID of a tree N is initialized to 1. In step 203, the procedure forms set A by including a source node and set B by including all destination nodes of the demand. In step 204, the procedure selects a node x form set A and a node d from set B such that distance between the pair of nodes is minimum. The pair of nodes and the ID of the selected route (x, d, ID), is recorded in tree C_{Z}. In step 205, nodes along the selected route connecting the pair of nodes (x, d) are included in set A and destination node d is removed form set B. In step 206, there is a check whether all destination nodes from set B are considered. If set B is non-empty, then the procedure repeats step 204, otherwise it follows step 207. Step 207 increases the tree ID Z. Step 208 finds a pair of nodes in a light tree C₁ such that if the route connecting the pair of nodes is replaced by one of the K shortest routes that is not yet considered in any of the light-trees, the increment in the length of a tree is minimized. Step 209 constructs a new tree C_{Z} by replacing the route ID of the selected pair of nodes by the ID of the route found in Step 208, and keeps the routes of other pair of nodes the same as in C₁. Step 210 checks whether K trees are found. If the number of found trees is less than K, then the procedure repeats step 207, otherwise the process follows step 211. At step 211, the K-Steiner tree procedure is terminated.

FIG. 10 shows the flow chart of the greedy clustering procedure in more details and the procedure is explained in detail as follows.

In step 301, there is constructed an auxiliary graph for a chromosome by considering each multicast tree encoded as a gene Pᵢ^{j} of the chromosome as an auxiliary node. An auxiliary link is established between a pair of auxiliary nodes if the corresponding multicast trees are sharing at least a physical link in the network. Each auxiliary node is confined in a cluster with a unique cluster ID defined in the chromosome. A unique cluster ID is assigned to each node of the auxiliary graph.

Step 302 evaluates the fitness of the chromosome by considering the assigned cluster ID to the respective multicast trees of the chromosome. The traffic over the multicast trees with the same cluster ID is considered to be groomed. Based on the groomed traffic, the maximum required spectrum over a fiber represents the fitness of the chromosome. The found fitness is recorded in Min-Fit variable. At step 303, the procedure selects a cluster that is not yet considered. Step 304 constructs auxiliary clusters by combining the selected cluster with its neighboring clusters in the auxiliary graph. Step 305 considers one of the auxiliary clusters that is not yet considered.

Step 306 checks whether the cumulative data rate of the multicast demands over the multicast trees confined within the selected auxiliary cluster is smaller than the maximum offered line rate. If the cumulative data rate is higher than the maximum data rate, then the procedure follows Step 308, otherwise the procedure follows Step 307. Step 307 evaluates the fitness of the chromosome while considering the auxiliary clusters along with the existing established clusters. The traffic over multicast trees within the auxiliary cluster is considered to be groomed and traffic over multicast trees with the same cluster ID is considered to be groomed. Based on the groomed traffic, the maximum required spectrum over a fiber represents the fitness of the chromosome.

Step 308 checks whether all auxiliary clusters are taken into account. If any of the auxiliary clusters is not yet considered, then the procedure follows Step 305, otherwise the procedure follows Step 309. Step 309 selects an auxiliary cluster whose fitness function is smaller than Min-Fit. Step 310 merges the confined clusters within the selected auxiliary cluster into a single cluster by assigning them the same cluster ID. The confined clusters are marked as considered clusters. Step 311 checks weather all the clusters are taken into account. If any of the clusters is not yet considered, then the procedure follows Step 303, otherwise the procedure follows Step 312. Lastly, 312 step returns the chromosome with the clustering information M_{i.}.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A computer implemented method for grooming multicast traffic in flexible optical wavelength division multiplexing WDM networks, the method comprising the steps of:
dividing a solution for grooming multicast traffic in flexible optical wavelength division multiplexing networks into a solving a multicast routing sub-problem, solving a a grooming sub-problem; and solving a wavelength assignment and spectrum allocation sub-problem;
i) employing a greedy clustering over sequential meta-heuristics (GRIST) procedure for solving the multicast routing sub-problem using a genetic evolution procedure;
ii) employing a greedy clustering procedure for solving the grooming sub-problem; and
iii) employing a simulated annealing procedure sequentially for solving the wavelength assignment and spectrum allocation sub-problem.

2. The method of claim 1, wherein the greedy clustering procedure constructs an auxiliary graph for a chromosome by considering each multicast tree encoded as a gene Pᵢ^{j} of the chromosome as an auxiliary node, the auxiliary link being established between a pair of auxiliary nodes if the corresponding multicast trees are sharing at least a physical link in the network, the greedy clustering procedure forming clusters of auxiliary nodes in the auxiliary graph with a greedy strategy and the greedy clustering procedure performing operations on the child chromosomes to determine grooming of traffic demands.

3. The method of claim 1, wherein the greedy clustering procedure evaluates fitness of a chromosome by considering assigned clusters IDs to the respective multicast trees of the chromosome, iteratively selects a cluster that is not yet selected in previous iterations, combining a selected cluster with each of its neighboring cluster to form an auxiliary cluster.

4. The method of claim 3, wherein the greedy clustering evaluates the cumulative data rate of traffic demands over all confined multicast trees within an auxiliary cluster, if the cumulative data rate of the cluster is larger than the maximum offered line rate, then the procedure ignores that auxiliary cluster. If the cumulative data rate is smaller than the maximum offered line rate, then the procedure evaluates the fitness function of the chromosome while considering the auxiliary cluster along with other established clusters, while evaluating the fitness of the chromosome, demands within a cluster are considered to be groomed, and demands within an auxiliary cluster are also considered to be groomed, the procedure evaluates a fitness of the chromosome for each of the auxiliary clusters and then selects an auxiliary cluster which results in minimum fitness of the chromosome that is smaller than Min-Fit.

5. The method of claim 1, wherein the greedy clustering procedure constructs an auxiliary graph for a chromosome by considering each multicast tree encoded as a gene of the chromosome as an auxiliary node, the fitness of a chromosome being defined as the maximum required spectrum on a fiber link in the network while ignoring the wavelength continuity constraint, which can be mathematically expressed as MaX_{(m,n)εE}Σ_{iεC}_{_{(m,n)}}Qᵢ, where Qᵢ denotes the optimum required spectrum to support the cumulative data rate of demands with the same cluster ID i, and C_{(m, n)} denotes a set of cluster IDs assigned to demands routed over the fiber (m, n).

6. The method of claim 1, wherein the greedy clustering over sequential meta-heuristics (GRIST) procedure comprises determining a logical connectivity of transparent light-trees from the multicast trees and their cluster IDs encoded as genes in the chromosome with the minimum fitness.

7. The method of claim 6, wherein each cluster is assigned a light-tree with an optimum line rate such that the capacity of the line rate is larger than the cumulative data rate routed over the confined multicast trees within the cluster and the required spectrum by the line rate is minimum, if the same cluster at an incoming port also exists at any of the outgoing ports, then the light-tree is considered to be bypassed, otherwise the light-tree is considered to be added/dropped at the node.

8. The method of claim 7, wherein once a logical connectivity is determined, the GRIST procedure subsequently solves the wavelength assignment and spectrum allocation sub-problem using the Simulated Annealing procedure, wherein a simulated Annealing is a probabilistic iterative method designed based on a physical process of annealing a solid.

9. The method of claim 1, wherein in the GRIST procedure, the simulated annealing first finds a set of transparent light-trees from the logical connectivity, an order of the found light-trees in which the wavelength assignment and spectrum allocation sub-problem is addressed is considered as a configuration of the Simulated Annealing procedure, an energy function E(C) to be minimized represents the maximum required spectrum over a fiber link in observance of the wavelength continuity, spectral continuity, and spectral conflict constraints

10. The method of claim 9, wherein the simulated annealing procedure adopts a first fit spectrum allocation to evaluate the energy function.

11. The method of claim 10, wherein the first fit spectrum allocation first constructs a bitmap of a light-tree by performing bitwise logical-and operations on the states of wavelength slots in the spectrum availability profile of each link along the light-tree, and finally, consecutive available wavelength slots equivalent to the required spectrum by the line rate of a light-tree are assigned at the lowest available wavelength, and the first-fit spectrum allocation procedure is performed in the order of light-trees defined in a configuration C, with a temperature being defined as a global time-varying parameter T, and an annealing schedule controlling how the temperature varies over time.

12. The method of claim 1, the simulated annealing of the GRIST procedure, to address the wavelength assignment and spectrum allocation sub-problem, performs a configuration initialization wherein initially a configuration C is a sequence of light-trees in a descending order of their required spectral width, and the energy E(C) of a configuration C is determined by solving the wavelength assignment and spectrum allocation sub-problem using the first-fit spectrum allocation procedure in the order of demands defined in the configuration C, and the maximum required spectrum over a fiber is considered as the energy of the configuration.

13. The method of claim 1, the simulated annealing of the GRIST procedure, to address the wavelength assignment and spectrum allocation sub-problem, performs configuration generation: wherein a new configuration N is generated from the current configuration C by swapping the order of two neighboring demands those are selected randomly.

14. The method of claim 1, wherein the genetic evolution procedure comprises generating a population for the genetic evolution procedure, for each multicast demand, a Steiner tree being randomly selected out of K-alternate Steiner trees, connecting a source node s to destination nodes D, with some distribution and assigns a unique cluster ID to the demand, where K-alternate Steiner trees are obtained through a K-Steiner tree procedure, the selected Steiner tree and assigned cluster ID being considered as the gene of a chromosome, and once a chromosome is derived, the procedure repeats the same procedure until the number of chromosomes equivalent to the given population size is generated.

15. The method of claim 14, wherein the genetic evolution procedure comprises introducing diversity in the population by a crossover operation on the selected parent chromosome, wherein in the crossover operation, based on the given crossover ratio, a number of chromosome segments (a group of genes) of the parent chromosomes are selected randomly and the selected segments are exchanged among the parent chromosomes to generate new child chromosomes.

16. The method of claim 1, wherein the greedy clustering procedure comprises constructing an auxiliary graph for a chromosome by considering each multicast tree encoded as a gene Pᵢ^{j} of the chromosome as an auxiliary node, an auxiliary link being established between a pair of auxiliary nodes if the corresponding multicast trees are sharing at least a physical link in the network, ad each auxiliary node being confined in a cluster with a unique cluster ID defined in the chromosome, and a unique cluster ID being assigned to each node of the auxiliary graph.

17. A system for grooming multicast traffic in flexible optical wavelength division multiplexing WDM networks, the system comprising;
a computer with processor and instructions for
dividing a solution for grooming multicast traffic in flexible optical wavelength division multiplexing networks into a solving a multicast routing sub-problem, solving a a grooming sub-problem; and solving a wavelength assignment and spectrum allocation sub-problem;
iv) employing a greedy clustering over sequential meta-heuristics (GRIST) procedure for solving the multicast routing sub-problem using a genetic evolution procedure;
v) employing a greedy clustering procedure for solving the grooming sub-problem; and
vi) employing a simulated annealing procedure sequentially for solving the wavelength assignment and spectrum allocation sub-problem.

18. The system of claim of claim 17, wherein the greedy clustering over sequential meta-heuristics (GRIST) procedure comprises determining a logical connectivity of transparent light-trees from the multicast trees and their cluster IDs encoded as genes in the chromosome with the minimum fitness.

19. The system of claim 17, wherein the greedy clustering procedure constructs an auxiliary graph for a chromosome by considering each multicast tree encoded as a gene of the chromosome as an auxiliary node, the fitness of a chromosome being defined as the maximum required spectrum on a fiber link in the network while ignoring the wavelength continuity constraint, which can be mathematically expressed as Max_{(m,n)εE}Σ_{iεC}_{_{(m,n)}}Qᵢ, where Qᵢ denotes the optimum required spectrum to support the cumulative data rate of demands with the same cluster ID i, and C_{(m, n)} denotes a set of cluster IDs assigned to demands routed over the fiber (m, n).

20. The system of claim 17, wherein the simulated annealing of the GRIST procedure, to address the wavelength assignment and spectrum allocation sub-problem, performs a configuration initialization wherein initially a configuration C is a sequence of light-trees in a descending order of their required spectral width, and the energy E(C) of a configuration C is determined by solving the wavelength assignment and spectrum allocation sub-problem using the first-fit spectrum allocation procedure in the order of demands defined in the configuration C, and the maximum required spectrum over a fiber is considered as the energy of the configuration.
